(19) United States
(12) Patent Application Publication
(10) Pub. No.: US 2009/0226693 A1
(43) Pub. Date: Sep. 10, 2009

(54) Concrete Fiber Material, Castable Constructs Including Same, And Methods

(75) Inventors: Nick Carter, Sacramento, CA (US); Michael DeWeese, Kingman, KS (US)

Correspondence Address: VALERIE CALLOWAY;CHIEF INTELLECTUAL PROPERTY COUNSEL, POLYMER GROUP, INC., 9335 HARRIS CORNERS PARKWAY SUITE 300, CHARLOTTE, NC, 28269, US

(73) Assignee: POLYMER GROUP, INC., Charlotte, NC (US)

(21) Appl. No.: 12/093,147

(22) PCT Filed: Dec. 15, 2006
(86) PCT No.: PCT/US06/48099

§ 371 Date: Nov. 10, 2008

Related U.S. Application Data
(60) Provisional application No. 60/750,864, filed on Dec. 16, 2005.

(51) Int. Cl. B32B 13/02; D02G 3/00; B29D 31/00

(52) U.S. Cl. 428/294.7; 428/359; 264/147

(57) ABSTRACT

A synthetic reinforcement fibrous material comprising releasable fibrous units during concrete mixing, where the fibrous units have a main filament element and plurality of integral outward extending subunits, useful as secondary reinforcement material and having a low Young's modulus for a more uniform distribution throughout a cementitious mixture incorporating the fibrous material, and imparts good finishability, strength, improved plastic shrinkage crack control, in also provides improved conformability within cementitious forms, especially within forms comprising bends. Improved cementitious compositions and fiber-reinforced concrete building products incorporating the synthetic fibrous material are also provided, as well as methods for making these materials.

### CROSS-REFERENCE TO RELATED APPLICATIONS

This application claims benefit of priority to U.S. Provisional Application No. 60/750,864, filed Dec. 16, 2005, which is hereby incorporated by reference in its entirety.

### TECHNICAL FIELD

The present invention generally relates to a synthetic reinforcement fibrous material for cementitious mixtures, and more specifically relates to a synthetic fibrous material useful for improving both pre-cure and post-cure properties of cementitious materials. The present invention is particularly useful simultaneously for shrinkage crack reduction and as a secondary reinforcement material, wherein individual fibrous units separated from the initial fibrous material exhibit a combination of: a) integrated surface anchors for improved capillary conduction and cementitious intercalation; b) low flexural modulus for a more uniform distribution throughout a cementitious mixture and enhanced finishing capabilities; and c) tensile properties allowing for effective post-crack bridging.

### BACKGROUND OF THE INVENTION

Many proposals have been made to reinforce, strengthen, or otherwise beneficially alter the properties of cementitious mixtures by applying and/or incorporating various types of components, including asbestos, glass, steel, and synthetic polymer fibers, to aqueous based concrete mixes prior to the placement and curing of the concrete. The types of synthetic polymer fibers in use or proposed for use include those composed of natural and synthetic composition. Exemplarly reinforcement fibers are disclosed in U.S. Pat. Nos. 6,071,613, 6,197,423, 6,265,056, and 6,503,625, all of which are hereby incorporated by reference.

Two forms of fibers currently used in producing concrete reinforcement from synthetic polymeric resins include those individual types directed to crack reduction from elastic shrinkage (i.e., pre-cure) and other individual types targeting secondary reinforcement for structural performance (i.e., post-cure). Crack reduction is obtained by using “simple” fibers, wherein the performance of reducing cracks is inherent to most any non-reactive, alkaline resistant fiber used in the mixture. Secondary structural reinforcement is obtained in a synthetic substrate through materials having performance attributes above those required in a simple crack reduction product.

All concrete or other cementitious materials undergo volumetric changes after placement. This volume change is caused by the loss of the significant water fraction from the cementitious mix during curing. Water is lost from the concrete due to evaporative effects and/or drainage or capillary action into subsoil beneath the concrete. A reasonable estimate of the percent of initial water fraction loss to the environment within the first twenty four hours is 80%. This fraction loss over time can be significantly impacted by environmental effectors, such as humidity, ambient temperature, wind velocity, and/or subsoil conditions. During the process of the placed concrete losing the water fraction and becoming solid in nature, tensile stress is imparted upon and within the forming cementitious construct. Additional tensile stresses are imparted by release of thermal energy by the curing concrete and by settlement of the forming structure. At any such point that the tensile stress exceeds the early and momentary tensile strength of the newly formed concrete or other cementitious construct, microscopic shrinkage cracks are induced. Shrinkage crack reduction fibers are targeted to bridging these micro-cracks, and as such are typically further divided into two sub-classifications; plastic shrinkage and drying shrinkage, wherein the differentiation is made as to whether the shrinkage occur pre- and post-initial concrete set, respectively. This initial concrete set typically occurs within the first four hours after placement of the concrete or other cementitious material, and initial cure within twenty-four hours, although this time may vary depending on materials and curing conditions.

Contrary to pre-cure performance fiber types, structural types of macro fibers should exhibit a suitable tensile strength sufficient to “bridge” a forming crack at a macro-level and retain overall performance of the concrete construct despite the loss of tensile strength resultant from the cement/aggregate/sand matrix alone in a cured cementitious mixture. When an external force, whether constant or instantaneous, is applied to a cast and cured cementitious construct, the matrix of the construct is incapable of withstanding the imparted load, and the matrix itself begins to fail through propagation of cracks throughout the structure. Cementitious constructs comprising secondary reinforcing fiber exhibit higher performance under an increasing level of structural stress and strain before and during the failure of the matrix. Ideally, the secondary reinforcing fibers act to bridge these cracks, and the construct is able to maintain a functional integrity. As the strain increases yet further, one of two general results tend to occur. Either the reinforcing fiber begins to lose its interfacial bonding to the matrix, and begins slipping, which will result in decreasing strength of the construct or the fiber tensile strength is exceeded and breaks in the region of the expanding crack, which will also results in decreasing strength of the construct.

Existing secondary reinforcement fibers, and particularly evident in prior art macro fibers such as glass and steel fibers, exhibit very high resistance to deflection in at least one physical dimension. For example, rigid drawn steel fibers, which may have bent ends, have been used to reinforce concrete. Also, rigid crenulated steel fibers have been used. Resistance to deflection of the secondary reinforcement fiber from a resting state, measured as Young's modulus, results in numerous issues in handling and resulting performance, such as difficulty loading into form structures, resistance to deflection during aesthetic finishing of the concrete construct, and induced heterogeneity in the forming matrix as the fibers themselves hinder or otherwise impede uniform distribution of, particularly, the aggregate components. Also, rigid reinforcing fibers, such as steel fibers or the like, tend to displace aggregate within the cementitious mix, which undesirably tends to lead to a non-uniform concrete construct or matrix.

Fibers resistant to deflection tend to nest while in a packaged state and at constriction points and bends in forms during the feeding process into the cementitious mix as well as impingement of pre-cured, free flow cementitious mix upon primary reinforcement structures (i.e. rebar) and flow constrains in molds or forms. Consequently, fibers resistant to deflection tend to nest or bridge at necking points or tight regions of primary reinforcement to hinder proper and complete filling of a concrete mold or former. This leads to non-uniform distribution of the fibers in the cementitious forms. Specific to distribution of secondary reinforcement fiber in molds and forms, such aforementioned fibers are generally found to poorly conform to bends in forms or molds of greater than, e.g., approximately 45 degrees, and have the potential to exhibit near zero distribution past bends of greater than 90 degrees without significant adaptations being made to the form to allow for these hindrances. Further, such fibers resistant to deflection render cementitious constructs difficult to finish on the open faces. Often, either enhanced finishing techniques or burnishing or active thermal degradation is necessary to remove reinforcing fiber extending beyond the surface of the concrete.

Moreover, steel fibers are susceptible to corrosion in the alkaline environment of concrete, and such corrosion can lead to loss of reinforcement strength and internal structural voids at the corroded sites. Rigid steel fibers also have finishability issues, as exposed fiber ends exposed from of the concrete surface must removed by grinding, and the like. Glass fibers, in addition to causing finishing problems, also tend to degrade over time.

Polypropylene monofilament fibers have been used for reinforcing concrete, and such monofilament fibers are more flexible, less resistant to deflection, and provide improved finishability. However, these fibers have low tensile strength, and their smooth surfaces do not offer sufficient anchoring capability, and consequently do not provide secondary reinforcement after cure. Synthetic crenulated filaments also have been used which offer more flexure than steel or glass, but during casting these filaments can nest due to conformability limitations and also finishing issues remain as exposed ends of the fibers need to be ground or burned off. Drawn homogenous synthetic tapes have also been used to reinforce concrete, which offer improved flexibility and precast conformability and finishability over steel fibers and crenulated synthetic fibers; however, these tapes do not tend to offer the ability to effectively reduce or limit micro-crack formation and propagation in pre-cured cementitious constructs.

Additionally, synthetic net-like fibrillated materials or fibrillated yarns made by mechanical slitting or air jet techniques, etc., have been described, e.g., in U.S. Pat. Nos. 3,273,771, 3,494,522, 3,470,285, 3,470,685, and 4,123,490. For purposes of these conventional fibrillated materials, “fibrillated” generally refers to mechanical processing of a tape to induce slits into the tape. These synthetic netting materials can provide more post-cure strength as compared to monofilament fibers, but do not finish well due to their tape-like manufacturing means. They tend to have a flexural rigidity problem in that when trowelled, bent free tape ends tend to spring back and extend away from the concrete surface. Prior fibrillated nets and yarns also have tended to have fibrils attached between adjoining stem members in a relatively fragile, non-durable manner such that the fibrils tended to detach and then did not contribute to in situ post-cure performance.

Concrete fibers having frayed ends have been disclosed, which are formed in situ by wet mixing sheath-core bicomponent fibers with concrete mix for a monitored amount of time, such as described in U.S. Pat. No. 7,025,825. However, the anchoring ability of these fibers is limited to the frayed ends. The smooth sides of these fibers tend to have limited or no anchoring ability in the cementitious materials. Microfibrillated filaments also have been disclosed which are formed in situ from wet mixing non-twisted plastic ribbons in concrete mix, such as described in U.S. Pat. No. 4,414,030. Such filaments are made from flat ribbons that have been mechanically fibrillated and spread out by air jet means prior to introduction into a mixing operation, where additional fiber shredding is indicated to occur. Therefore, the fibrillation of these filaments requires numerous manufacturing steps, and through the mechanism of operation, the resulting fibrillated products will tend to have less reproducibility due to the inherent variability of the components used in the cementitous construct.

The cementitious reinforcement materials of the prior art have generally focused on a singular performance level within an individual fiber, with compound performance in concrete being addressed, e.g., through blending of different types of singular performance fibers, which has the disadvantage that a uniform cementitious mix becomes difficult to provide and maintain, and, in particular, tends to result in a non-uniform distribution of the fibers in the cured concrete.

A need exists for a concrete reinforcement fiber or fibrous material that is a ready-to-use reinforcement structure that can improve both pre-cure and post-cure properties of cementitious materials that are reinforced with it, such as by exhibiting effective anchoring and bridging of cracks (both micro and macro) in concrete, conformability to the cementitious matrix itself, sufficient finishability, and the ability to uniformly disperse in a homogenous state and maintain this state through the concrete or other cementitious material curing timeline.

### SUMMARY OF THE INVENTION

The present invention is directed to a ready-to-use, multimodal synthetic reinforcement fibrous material useful as both a shrinkage crack reduction and as a secondary reinforcement material in cementitious materials. The synthetic fibrous material comprises a plurality of individual fibrous units that release from the source material under low shear stresses and disperse evenly within and conform to a cementitious mixture, inhibiting the propagation of microcracks, and imparting flexural toughness throughout. The fibrous material exhibits a low Young's modulus such that its released fibrous units have a more uniform three-dimensional distribution throughout a cementitious mixture, tensile properties that allow for effective management of macro-level crack formation, and combined capillary conduction of the water fraction with effective management of micro-level crack propagation. The synthetic released fibrous units particularly provide improved conformability within cementitious forms, especially within forms comprising bends, such as those equal to or greater than about 45 degrees, such that the reinforcing fiber does not nest in bends or constrictions defined by forms or molds. The released fibrous units also do not displace aggregate within the cementitious mix, ensuring a more uniformly dispersed concrete matrix. The released fibrous units also increase spalling resistance (e.g., shatter resistance) and abrasion resistance, improving the reinforced concrete's long-term durability and integrity.

In accordance with one embodiment of the present invention, a synthetic reinforcement fibrous material comprises a plurality of parallel-extending spaced-apart main filament elements interconnected by intervening integral webbing material, wherein individual fibrous units are separable from the reinforcement fibrous material during mixing of the fibrous material and a curable cementitious material. The individual fibrous units each comprise a main filament element having opposite sides, and a plurality of integral fibrous subunits laterally extending from the main filament element at a random frequency along the opposite sides thereof, and the subunits have random respective lengths and diameters. These fibrous units disperse and conform well within cementitious materials within which they are released during concrete mixing and casting.

In a particular embodiment, the reinforcement fibrous material, and hence each separable individual fiber unit releasable therefrom, are formed of a homogeneous polymeric blend that has been formed into a structure comprising two primary structural elements. The first element is a main filament element or “trunk” and the second element comprises subunits or roots that are integrally formed and laterally extend from opposites sides of the trunk. The main filament element extends essentially the entire length of the overall fibrous unit and comprises a cross-sectional area that predominates the overall cross sectional area of the entire fiber construct or unit. The plurality of subunits or roots are arrayed adjacent and randomly spaced-apart from one another along the length of each opposite lateral side of the main filament element. These subunits exhibit proximal and distal regions relative to the fiber main filament element. The proximal region is where the subunit originates from and is integrally anchored to the fiber main filament element, and the distal region is the opposite free end of the subunit member. An individual subunit laterally extends away from the main filament element at an angle of between 1 and 90 degrees, particularly between about 45 and about 90 degrees, from the origination point at the main filament element relative to the longitudinal dimension of the overall synthetic fiber unit of the present invention. The main filament element may have a staple fiber length of about 6 to about 80 mm, and particularly about 18 to about 40 mm. The individual subunits may have a length averaging about 10 microns or more, up to and including the total staple length of the overall fiber, as measured via magnified view between the proximal region to the distal region thereof, and the subunit lengths preferably range from about 50 microns to about 500 microns.

In a preferred embodiment, the reinforcement fibrous material, and hence the separable synthetic fibrous units thereof, comprise a multi-polymer blend. In embodiments suited for high strength applications of the fibrous material in concrete, the multi-polymer blend preferably comprises refractional melt polymer in an amount of between about 0.05% to about 40% by weight, about 50% to about 98% by weight synthetic homopolymer(s) having a substantially lower melt flow rate than the refractional melt polymer, and about 1% to about 10% by weight softening polymer. In a particular embodiment, the synthetic fiber unit is formed of a multi-polymer blend comprising about 0.05% to about 40% by weight refractional melt polypropylene polymer, about 50% to about 98% by weight synthetic polypropylene homopolymer having a substantially lower melt flow rate than the refractional melt polymer and/or other synthetic resins that can form a compatible blend or alloy with the refractional melt polymer, about 1% to about 10% by weight of linear polyethylene, and 0 to about 10% plastic additives (e.g., conventional ones). The refractional melt polymer content in the fibrous material imparts increased polymer crystallinity, which has been discovered to provide subunits having subunit roots that are more durably-attached to the main filament element during wet concrete mixing, etc. In concrete applications where lower tensile strength fibrous reinforcement is acceptable, the resin composition may comprise a major amount of synthetic homopolymer(s) and a minor amount of linear polyethylene, and the refractional melt polymer may be omitted.

In one embodiment, the main filament element has a substantially uniform cross-section along its length, and the subunits have substantially uniform cross-sectional diameters along their length from the proximal end to the distal end thereof. In one embodiment, at any point taken along the length of the inventive fibrous unit, the cross-sectional area of the main filament element represents between 75 to 99.9%, and preferably between of 85 to 98%, and most preferably between 95 to 98% of the overall cross-sectional area of the fibrous unit at that location, and the cross-sectional area of the subunits present at that location along the fibrous unit constitute the remainder (e.g., 0.1 to 25%, etc.) of the overall cross-sectional area of the fibrous unit. For the purposes of conformability to the matrix and finishability, the cross sectional geometric profile of the main filament element of the separable fibrous unit is preferably within the ratio range of 1 to 3 in terms of a measure taken from the longer of two perpendicular lines that transect a central point within the profile divided by the shorter of the two perpendicular lines. More preferably, this comparison of width and height is in the ratio range of 1 to 2 and most preferably in the ratio range of 1 to 1.5. In a further embodiment, the above-mentioned synthetic fibrous unit has a thickness of between 1.0 and 3.5 ml, and a preferred range of 1.25 to 3.0 mil. Further, the cross sectional profile of the main filament element may approximately define rectangular, polygonal, oval, and circular geometries, wherein this list also may represent their respective order of preference with rectangular being most preferred. Other symmetric or asymmetric geometries also may be used.

The separable synthetic fibrous material of the present invention has adequate structural integrity and strength such that the majority if not essentially all the subunits of an individual separable fiber sub-unit remain connected to the trunk portion of the fiber during wet concrete or other cementitious material mixing.

As other embodiments, improved hydratable cementitious compositions and fiber-reinforced concrete building products incorporating the reinforcement fibrous material in accordance herewith are also provided. Although not limited thereto, applications of the fiber-reinforced hydratable cementitious compositions include, e.g. precast products, backing boards, stuccos, mastics, mortars, thin sets, cast in place pieces, and concrete slab construction. In particular, these applications include, e.g., formed or molded concrete shapes, industrial and warehouse floors, commercial slab construction, concrete pavement, white topping and overlays, and so forth. A cementitious mix reinforced with the inventive reinforcement fibrous units flows well within the casting forms. Use of the reinforcing fiber according to embodiments herein also can reduce or eliminate the need for welded wire fabric, conventional light gauge steel reinforcement and steel fiber in concrete mixes. Handling and transportation stresses are beneficially reduced and improved green strengths are obtained, thus permitting earlier stripping of forms, and closer tolerances to precast forms are provided. Effective settlement control and good finishability is additionally imparted, and production time and overall material costs may be reduced using reinforcing fiber according to embodiments herein.

The above-mentioned synthetic reinforcement fibrous material preferably exhibits a Young's modulus at 30% elongation of less than 3.0 and 9.5 Gpa, and preferably in the range of between 3.0 and 8.5 Gpa, and most preferably between 3.0 and 5.0 Gpa. The synthetic fibrous reinforcement materials, and latently-releasable fibrous units, of the present invention are effective to improve both pre-cure and post-cure properties of cementitious materials such as concrete. In one embodiment, when utilized in a cementitious mix and processed in accordance with ASTM C94, the synthetic fibrous units provide a residual strength per ASTM C1399 of at least 80 psi at 3 lb per cubic yard loading at 8 days cure. Fiber reinforced concrete building products according to this invention exhibit a 20% increase in force to initiate crack per ASTM C1609. The fiber reinforced concrete building products also exhibit a crack reduction per ASTM C1579 of at least 50%. These aforementioned ASTM tests are incorporated herein by reference.

A method for making the reinforcement fibrous material possessing the separable synthetic fibrous units is also provided. The synthetic reinforcement fibrous material is a product that is produced by a unique manufacturing process providing an intact on-demand source of fibrous units, which is ready-for-use in wet or dry mixing of concrete ingredients. In one embodiment, the reinforcement fibrous material is made by a continuous or semi-continuous process that comprises extruding a striated ribbon from a thermoplastic composition comprising the above-mentioned blend of polymers, e.g., the blend of refractional melt polymer and other synthetic resin(s). The striated ribbon has a plurality of substantially uniformly, laterally spaced parallel ribs extending continuously and longitudinally of the ribbon. The adjacent pairs of ribs are interconnected by integral thermoplastic webs of reduced thickness as compared to the ribs. The striated ribbon can be formed, e.g., with a serrated extrusion die arrangement. The striated ribbon is slit into a plurality of smaller width ribbons. Then the slit ribbons are incrementally drawn or stretched, such as using Godet rolls, in a heated condition, at a high draw ratio, such as between 4.5:1 to 15:1. This drawing procedure encourages orientation and strength development in the ribbons, particularly with respect to ribbons containing refractional or highly isotactic polyolefin content. The ribs have sufficiently greater tensile strength such that they do not tear during drawing and retain their continuous integrity. The drawn striated ribbon may be immediately transversely cut into discrete fiber lengths by transversely cutting the ribbon, or otherwise collected in roll form for later cutting. The cut ribbon portions may be packaged for transport, handling, and use. For example, they may packaged in easy-to-use water-dispersible bags or the like that may be used on demand in cement mixing and pouring applications. The unitary fibrous material has the latent ability to release discrete individual fibrous units therefrom during cement mixing or under comparable shear conditions, such as mixing conditions according to ASTM C-94. The released individual fibrous units have the structural features described herein including the main fiber elements and the integral laterally extending subunits. The individual fibrous units are stable and sufficiently durable such that the integral subunits thereof do not significantly break away from the main filament elements during concrete mixing, pouring, and curing.

For purposes of this application, “Young's modulus” refers to a measure of the stiffness of a given material. It is defined as the limit, for small strains, of the rate of change of stress with strain. This can be determined, for example, from the slope of a stress-strain curve created during tensile tests conducted on a sample of the material. A “cementitious material(s)” refers to a material containing cement. “Concrete” is a cementitious material that comprises, in its most common form, although not exclusively, Portland cement, sand, construction aggregate, and water. A “refractional melt polymer” or “refractional polymer” refers to a resin having a melt flow rate of above 1, as measured by ASTM D1238, I₂ at 230° C. As used herein, the terms “highly isotactic” and “crystalline” may be defined, e.g., as set forth in U.S. Pat. No. 6,806,316, which descriptions are incorporated herein by reference. In this regard, “highly isotactic” may be defined as having at least 60% isotactic pentads according to analysis by ¹³C-NMR. “Crystalline” may be defined as having identifiable peak melting points above about 100° C. as determined by Differential Scanning Calorimetry (DSC peak melting temperatures). “Multimodal” refers to a material having both pre-cure and post-cure performance.

### BRIEF DESCRIPTION OF THE DRAWINGS

FIG. 1 is an enlarged plan view of a reinforcement fibrous material according to an embodiment of the present invention.

FIG. 2 is an enlarged cross-section view of the reinforcing fibrous material of FIG. 1.

FIG. 3 is a significantly enlarged plan view of an individual fibrous unit derived from a reinforcement fibrous material according to an embodiment of the present invention.

FIG. 4 is a schematic representation of an apparatus useful for practicing a process for making the reinforcement fibrous material according to FIG. 1.

FIG. 5 is portion of a serrated extrusion die for use in the apparatus of FIG. 4.

FIG. 6 is a cross-sectional view taken along line 6-6 of a fibrous unit according to FIG. 3.

FIG. 7 is a partial sectional view of a cementitious material containing fibrous units such as shown in FIG. 3.

Features shown in the drawings are not necessarily drawn to scale. For instance, in FIGS. 1-3, 6, and 7, the size of some features, such as fibrous subunits or branches connected to main filament elements of fibrous units, may be exaggerated to help identify their presence for purposes of the related descriptions provided herein. Elements in the drawings that are identified by the same number refer to similar features unless indicated otherwise.

### DETAILED DESCRIPTION

While the present invention is susceptible of embodiment in various forms, there is shown in the drawings, and will hereinafter be described, a presently preferred embodiment, with the understanding that the present disclosure is to be considered as an exemplification of the invention, and is not intended to limit the invention to the specific embodiment illustrated.

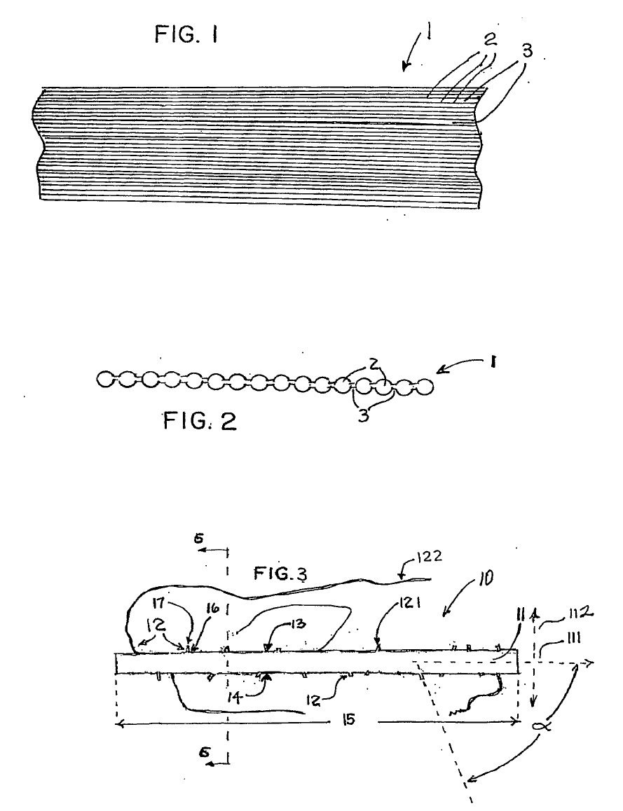

Synthetic Reinforcement Fibrous Material. Referring to FIG. 1, a synthetic reinforcement fibrous material 1 according to an embodiment of the invention is shown comprising a plurality of substantially uniformly space-apart, longitudinally-extending main filament elements 2 and intervening integral webbing material 3. FIG. 2 is an enlarged sectional view of the fibrous reinforcement material 1. In a preferred embodiment, the reinforcement fibrous material 1 is formed of a homogeneous polymeric material that is extruded as a single layer of material. The reinforcement fibrous material is a unitary (single piece), discrete length ready-to-use component or element. Upon introduction into either wet or dry cementitious mixes, such as concrete, each introduced reinforcement fibrous material element is capable of releasing a large number of individual performing fibrous units described herein that disperse evenly and conform to the mix.

Separable Individual Performing Fibrous Unit. Referring to FIG. 3, a synthetic individual performing fibrous unit 10 in accordance with an embodiment of the present invention is illustrated. The individual performing fibrous unit 10 is formed of a synthetic polymer material that has been formed into a structure comprising two primary structural elements 11 and 12. The first element is a main filament element or “trunk” 11 and the second element comprises subunits or “branches” 12 that are integrally attached to and laterally extend from opposites sides 13 and 14 of the trunk 11. The main filament element 11 extends in a longitudinal direction 111 for a discrete length 15. The subunits 12 generally extend away from the main filament element 11 towards the transverse or widthwise direction 112 that is oriented perpendicular to the fiber's longitudinal direction 111. The plurality of subunits 12 are arrayed adjacent and spaced-part from one another along the length 15 of each opposite lateral side 13, 14 of the main filament element 11. The subunits 12 are randomly spaced apart from one another along the length of the main filament element 11. These subunits exhibit proximal and distal regions 16 and 17 relative to the main filament element 11. The proximal region 16 is where the subunit 12 originates from and is integrally anchored to the fiber main filament element 11, and the distal region 17 is the opposite free end of subunit 12. An individual subunit 12 may randomly laterally extend away from the main filament element 11 at an angle alpha (α) anywhere between 1 and 90 degrees from the origination point at the main filament element 11 relative to the longitudinal dimension 15 of the overall synthetic fiber 10 of the present invention. Longer subunits may meander in different directions away from the main element 11, such as indicated in FIG. 3. The main filament element 11 may have a staple fiber length 15 of about 6 to about 80 mm, and particularly about 25 to about 40 mm. Individual subunits 12 may have a length averaging about 10 microns or more, up to approximately the same value as the total staple length 15 of the overall fiber 10 between the proximal region 16 to the distal region 17 thereof. The subunit lengths preferably range from about 50 microns to about 80 mm, particularly about 500 microns to about 6 mm. Subunits 12 may have a diameter that is up to about 20% of that of the main filament element 11.

As shown in FIG. 3, an individual fibrous unit 10 may include integral subunits 12 having a variety of different lengths and widths (e.g., short barbs 121, fine long hairs 122, etc), which are generally randomly connected at only one end to the remaining main filament element 11. Fibrous units 10 are essentially free of, or completely free of, fraying at the opposite ends of main element 11. Instead of frayed ends, fibrous units 10 of the present invention are based on a different approach. The random arrangement of subunits, in terms of locations along the main filament element 11 and subunit dimensions, provides reinforcing units that are less apt to behave similarly within a concrete mix. Subunits 12 have surface energies that are different, which tends to help keep them apart and promotes improved dispersion of the individual fibrous units within cementitious mixes. This separation and improves dispersion, reducing nesting or clustering problems with respect to the reinforcement fibrous material and released fibrous units thereof, including areas otherwise vulnerable to such problems such as in bends in a concrete form. Although not shown in FIG. 3, subunits may also have integral smaller fibrous splinters or sub-branches extending therefrom.

Resin Composition. In one embodiment, the synthetic fibrous material, and hence each of the fibrous units derived therefrom, is made with a resin composition comprising a combination of two or more different synthetic polymers, such as, for example, a physical mixture or resinous “alloy” of polyolefins. For instance, the synthetic resin composition of the reinforcement fiber may be a blend or alloy in whole or part of refractional melt polymer with other natural or synthetic polymers, such as polyamides, polyesters, polyolefins, polyvinyls, polyacrylics, and blends or coextrusion products thereof. One or more of the synthetic polymers may be selected from homopolymers; copolymers, conjugates and other derivatives, including those thermoplastic polymers having incorporated melt additives or surface-active agents. In a particular embodiment, the synthetic fiber material is made exclusively or essentially exclusively with a polypropylene/polyethylene blend alone, or alternatively a polypropylene/polystyrene blend alone, and in the absence of additives or other forms of polymeric ingredients, as the resin composition that is processed as described herein. The polypropylene may be used as a single type or combined types of polypropylene.

In concrete slab or precast applications where higher tensile strength is desirable, the polypropylene preferably may comprise combined usage of a highly isotactic (crystalline) or refractional melt polypropylene homopolymer and a high molecular weight polypropylene homopolymer having a significantly lower melt flow rate as compared to the highly isotactic polypropylene homopolymer. In a preferred embodiment of such high tensile strength materials, the resin composition is a ternary multipolymer physical blend or combination of polymer components comprising (a) a highly isotactic polypropylene homopolymer, (b) high molecular weight polypropylene homopolymer of significantly or substantially lower melt flow rate than the first-mentioned type of polypropylene, and (c) high strength linear polyethylene. Component (b) in this preferred embodiment is typically a predominant or major component of the blend from the standpoint of its weight percentage of the overall resin composition, while components (a) and (c) are contained as minor components of the blend. The refractional melt polymer (a) tends to imparts improved strength and durability to the blend, and the linear polyethylene (c) tends to impart imparts softness. In a particular embodiment, the synthetic fibrous material is formed of a multi-polymer blend comprising (a) about 0.05% to about 40% by weight refractional melt polypropylene polymer, (b) about 50% to about 98% by weight synthetic polypropylene homopolymer having a substantially lower melt flow rate than the refractional melt polymer, (c) about 1% to about 10% by weight linear polyethylene, and (d) 0 to about 10% by weight plastic additives (e.g., conventional ones). Refractional melt polymer(s) in the fibrous material tends to impart increased polymer crystallinity, which has been discovered to provide subunits having subunit roots that are durably-attached to the main filament element of the fibrous unit during wet mixing, etc.

In a preferred embodiment, highly isotactic polypropylene homopolymer(s) useful in the present invention may have a melt flow rate of about 3.8 to about 4.2 g/10 min (ASTM D1238, I₂ at 230° C.), a density of about 0.89 to 0.91 g/cm³, and elongation at yield (ASTM D638, 50 mm/min) of about 8 to about 10%. The high molecular weight polypropylene homopolymer may have a melt flow rate of about 0.4 to about 0.6 g/10 min (ASTM D1238, I₂ at 230° C.), a density of about 0.89 to 0.91 g/cm³, and elongation at yield (ASTM D638, 50 mm/min) of about 8 to about 10%. Therefore, highly isotactic polypropylene resin (a) may be used in the resin composition which has a melt flow rate (ASTM D1238, 230° C.) that is about 6 to about 10 times higher (i.e. about 6× to about 10× higher), particularly, about 7 to about 9 times higher, than that of the polypropylene homopolymer resin (b). The high strength linear polyethylene may have a melt flow rate of about 0.9 to about 1.1 g/10 min (ASTM D1238, 190° C./2.16 kg), a density of about 0.91 to 0.93 g/cm³, and elongation at break (ASTM D882) of about 725% to about 775% (M.D.—machine direction) and about 975% to about 1000% (T.D.—transverse (cross) direction). The physical properties of the overall resin may be a specific gravity of about 0.91, an ignition point of about 590° C., a melt point of about 160° C., and has essentially no water absorption. These resin compositions have excellent alkali and chemical resistance in cementitious compositions. As one non-limiting resin composition, it contains about 16% by weight of the above-described highly isotactic refractional melt polypropylene, about 77.5% by weight of the high molecular weight polypropylene homopolymer, about 4% by weight of the high strength linear polyethylene, and about 2.5% by weight conventional plastic additives such as colorants, etc. Multipolymer blends such as described in U.S. Pat. Nos. 6,592,790 and 6,503,625, the disclosures of which are hereby incorporated by reference, also may be suitable as the resin composition.

In concrete slab or precast applications where lower tensile strength fibrous reinforcement is acceptable and tolerable, the resin composition may comprise a major amount of synthetic polypropylene homopolymer(s) (b), and a minor amount of linear polyethylene (c), and the refractional melt polypropylene polymer (a) may be omitted or otherwise is present in an amount less than 0.05% refractional melt (e.g., 0 up to 0.05%). The amounts of the synthetic polypropylene homopolymer and linear polyethylene can be proportionally adjusted upward relative to the above-described formulations to account for the absence of the refractional melt polymer component in this embodiment.

For fiber formation, the resin composition, such as a polyolefin stock material (e.g., pellets, powders, etc.), is heated, mixed and extruded into a sheet or ribbon, e.g., a striated ribbon that is processed in the following manners to form fibers.

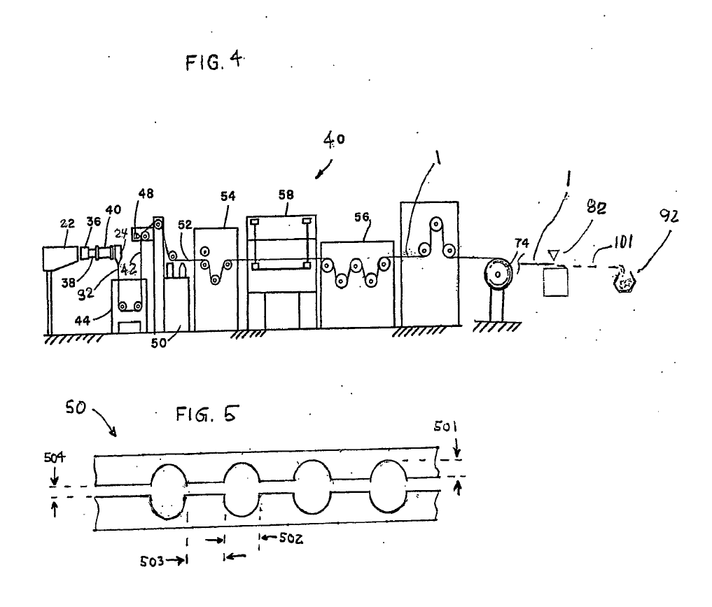

Reinforcement Fibrous Material Formation Process. Referring to FIG. 4, a process 40 of making the synthetic reinforcement fibrous material 1 is conducted as a continuous or semi-continuous procedure. Contrary to conventional fibrillation processes whereby a monolithic tape is cut from a formed film sheet and subjected to mechanical scoring by pin cans, the process for forming the reinforcement fibrous material 1 that embodies separable fibrous units 10 generally comprises extruding a polymer blend in the form of a striated ribbon as the extrudate from an extruder having a serrated extruder die, and then slitting the extrudate into a plurality of separate continuous ribbons of lesser width than the extrudate, which are incrementally oriented, transversely cut into discrete lengths, and then packaged.

As illustrated in FIG. 4, an apparatus 40 is shown for making and packaging synthetic reinforcement fibrous material 1 according to the present invention. The apparatus 40 extrudes a sheet of striated polymeric film 32, which is quenched to provide striated ribbon 42, which is longitudinally slit into a plurality of smaller width ribbons 52, which are incrementally drawn to provide a plurality of longitudinally extending, oriented synthetic striated ribbons 1.

The extruding apparatus 22 includes an appropriate feed hopper (not shown) which receives synthetic material, such as, for example, thermoplastic resin blends such as described herein, as well as recycled chopped edge trim of the same or similar production lines, which is melted and mixed therein. For high strength applications, the thermoplastic composition used to form the striated ribbon preferably comprises the above-described blend of refractional melt polypropylene, polypropylene homopolymer having a substantially lower melt flow rate than the refractional melt polymer, linear polyethylene, and optionally other synthetic resin(s) and conventional plastic additives. For applications where high strength reinforcement may not be required, e.g., concrete pedestrian walkways, a polymer blend may be used containing the polypropylene homopolymer and linear polyethylene, and optionally other synthetic resin(s) and conventional plastic additives. A screen element 36 may be provided in the extruding apparatus 22 for removing contaminates. The molten polymer is then presented at a low pressure to the inlet of a gear pump 38 where it passes to a static mixer 40 which serves to homogenize the polymer blend composition and provide a uniform melt temperature for the molten polymer. The molten polymer is then fed to a serrated extrusion die 24 where it is then extruded into a sheet 32. The extruded sheet 32 then passes to a quench tank 44, and/or through or around other cooling means (e.g., a chill roller), for quenching and setting the striated polymeric material 32 to thereby form a non-oriented striated sheet 42 of polymeric film. Preferably the ribbon extrusion step is accomplished with a serrated die operable to form the series of striations of alternating thinner and thicker thickness relative to the transverse (cross-wise) direction across the extruded ribbon. Serrated die arrangements for extruding plastic ribbons that can be readily adapted to form the striated ribbons are generally known in the art, such as those described in U.S. Pat. Nos. 3,470,685 and 4,123,490, which are incorporated herein by reference.

The non-oriented striated sheet 42 is then taken away by a driven nip roll 48 and is passed through a conventional slitter mechanism 50 which serves to longitudinally slit the striated sheet 42 to various widths to provide a plurality of longitudinally extending ribbons or tapes 52 that are being concurrently conveyed through the system 40. In a non-limiting illustration, the extruded striated sheet 42 may have a width of about 45 to about 60 inches (114 cm to 152 cm), and the non-oriented slit ribbons 52 that are formed may have individual thicknesses of about 8.0 mils to about 20 mils (0.0080 inch to 0.02 inch). At the slitter mechanism 50, the striated sheet 42 also may be trimmed to eliminate longitudinal edge portions, which may tend to break or fracture during the subsequent orientation process, and the trimmed edges being continuously fed back to the extruding apparatus 22 for re-use. The series of non-oriented ribbons or tapes 52 are then oriented, such as by heating the ribbons 52 and stretching or drawing the heated ribbons 52. This is accomplished, for example, by feeding the ribbons 52 between first and second Godets 54, 56 while passing the ribbons 52 through an intervening oven 58. For the ternary polymeric blend materials containing refractional melt polymer content as described herein, the oven temperature may be approximately 450 to 500° F. (232 to 260° C.), depending upon the orientation speed. For other polymer blends described herein, the oven temperature may be approximately 250 to 350° F. (121 to 177° C.). The second Godet 56 is operated at from five to fifteen times the rate of the first Godet 54, preferably from seven to twelve times the rate of the first Godet 54, and more preferably from eight to ten times the rate of the first Godet 54, so that the ribbons 52 are stretched or elongated to thereby produce oriented striated ribbons 1 which are oriented primarily along their longitudinal length. That is, the striated ribbon 52 may be subjected to a draw ratio of about 4.5:1 to 15:1, particularly about 7:1 to about 12:1, and more particularly about 8:1 to about 10:1. The ribbons 52 neck somewhat during the orientation treatment, but in a manner that does not remove or deform the striated geometry of the ribbon. Although two sets of Godet rolls are illustrated, the orientation step is not limited to that number. This incremental drawing operation is effective to provide an oriented fibrous reinforcing material 1. As to other wherewithal features of the ribbon forming system, the ribbon forming systems such as described in U.S. Pat. Nos. 4,433,536, 3,494,522, 3,470,285, 3,470,685, and 4,123,490, which are incorporated herein by reference, may be adapted and modified as applicable for use in forming the striated oriented ribbon described herein.

Referring to FIGS. 1 and 2 again, at this juncture in the process, the striated ribbons 1 each has a plurality of substantially uniformly, laterally spaced parallel ribs 2 extending continuously and longitudinally of the ribbon. The adjacent pairs of ribs 2 are interconnected by integral thermoplastic webs 3 of reduced thickness as compared to the ribs. The relative thicknesses of the ribs 2 and webs 3 can be dictated by choice of the serrated die dimensions. As a non-limiting example, and referring to FIG. 5, the serrated die 50 may incorporate the following dimensions: 501=0.60 mm, 502=1.19 mm, 503=0.31 mm, and 504=0.76 mm. The extrusion orifices may be circular, triangular, or rectangular shaped, or have another shape corresponding to a desired rib shape to be formed in the extrudate. The width of the striated ribbons 1 that are formed and processed is not necessarily limited other than by practical considerations of scale of equipment and process layout. As one illustration, the oriented striated ribbon film 1 may have a width, for example, of about 12 mm to about 26 mm, although not limited thereto. Each oriented striated ribbon 1 may have about 20 to about 100 rib elements 2 per inch of ribbon width. The highly oriented ribbons 1 generally contain a pattern of incipient fracture lines along which the film can be induced to split spontaneously, such as for example by twisting, rubbing and/or stretching techniques associated with concrete shear forces, whereupon a plurality of individual discrete fibrous units 10 release from each common source element 1, which have a random, non-uniform pattern of integral subunits connected thereto.

The drawn striated ribbon(s) 1 may be taken up on a collection reel 74, or, alternatively, continuously fed from the orientation and stretching station to a cutting station 82 where each ribbon 1 is cut into discrete fibrous material lengths by transversely cutting the ribbon, such as with a conventional tow cutter. The cut fibrous material lengths are not particularly limited, and may be, e.g., about 10 mm to about 100 mm, particularly about 30 mm to about 50 mm, or other lengths. The cut lengths 101 of reinforcing fibrous material 1 can be packaged, such as in water-dispersible plastic bags 92 or other suitable containers.

Additional Fiber Characteristics. Referring again to FIG. 3, in one embodiment the main filament element 11 of a fibrous unit released from the fibrous material 1 has a substantially uniform cross-section along its length 15, and each of the subunits 12 have substantially uniform cross-sectional diameters along their length from the proximal end 16 to the distal end 17 thereof. It will be understood that individual subunits 12 may have substantially uniform cross-sectional diameters, but that the diameters can vary from subunit to subunit. The main filament element 11 of synthetic fibrous unit 10 may have a diameter of between about 1.0 and about 6 mil (25 to 152 micrometers), with a preferred range of about 3.0 to about 5.0 mil (76 to 127 micrometers). The subunits 12 generally have a diameter that is up to about 20% of the diameter of the main filament element 11. In one embodiment, the main filament element 11 has a diameter of about 90 to about 110 micrometers, and the subunits 12 have diameters up to about 20 micrometers.

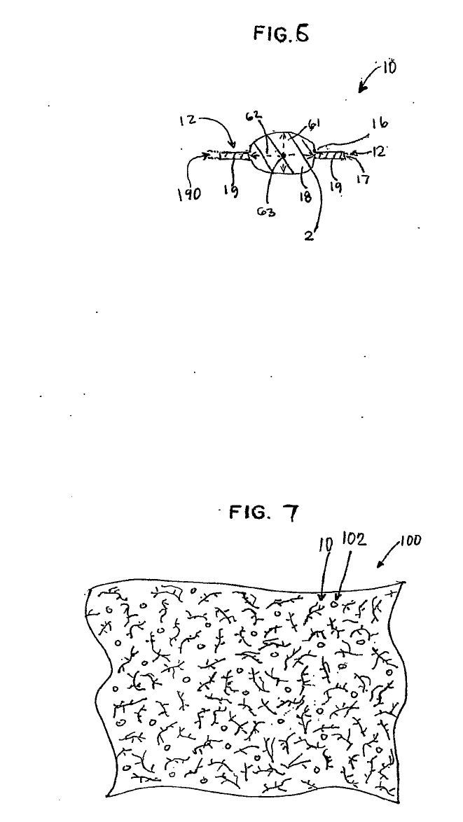

Referring also to FIG. 6, in one embodiment, at any point taken along the length 15 of the inventive fibrous unit 10, the cross-sectional area 18 of the main filament element represents between 75 to 99.9%, and preferably between of 85 to 98%, and most preferably between 95 to 98% of the overall or combined cross-sectional area (18+19) of the fibrous unit 10 at that location, and the total cross-sectional area 19 of the subunits or branches 12 present at that same location along the fibrous unit 10 constitute the remainder (e.g., 0.1 to 25%, etc.) of the overall cross-sectional area of the fibrous unit for purposes of this stated relationship. In the illustrated embodiment, the subunits 12 have a substantially uniform thickness 190 between the proximal end 16 and distal end 17. For the purposes of conformability to the matrix and finishability, the cross sectional geometric profile of the main filament element 2 of the fibrous unit 10 is preferably within the range of 1 to 3 in terms of a measure taken from the longer line segment (61) of two perpendicular lines 61, 62 that transect a central point 63 within the profile divided by the shorter line segment (62) of the two perpendicular lines. More preferably, this comparison of width and height is in the range of 1 to 2 and most preferably in the range of 1 to 1.5.

Further, although illustrated as a circular cross-sectional shape in FIG. 2 herein, the cross sectional profile of the main filament element 2 may approximately define many shapes such as a rectangular, polygonal, oval, and circular geometries, wherein this list also may represent their respective order of preference with circular being most preferred. Other geometries also may be used.

Reinforced Cementitious Materials. In accordance with the present invention, a plurality of Individual fibrous units 10 are released by each fibrous material 1 by shearing forces associated with wet mixing of concrete or other cementitious compositions, such as concrete mixed in accordance with ASTM C-94 or similar or greater shear conditions. The reinforcement fibrous material may be used in combination with cementitious materials containing hydraulic cements, non-hydraulic cements, or other cementitious materials. Referring to FIG. 7, the synthetic reinforcement fibrous units 10, after release from the fibrous material 1 and distribution during concrete mixing, exhibit strength and improved flexibility, as well as are endowed with inherent and improved dispensability and dispersability into organic or inorganic cementitious matrixes 100, such as concrete, mortar, plaster, grout, etc., which may contain dispersed aggregate 102 in addition to the reinforcing fibers 10 and other matrix components. For example, when a concrete mix is dosed with the reinforcement fibrous material at a rate of at least about 1.5 pounds per cubic yard (0.1% by volume), a very large number of the individual fibrous units, which can reach up into 10's of millions thereof depending on the scale of the project, are dispersed throughout the entire mix, inhibiting the propagation of micro cracks and imparting toughness throughout, amongst other benefits.

The proportion of individual fibrous units 10 released from each fibrous material or element 1 into a concrete mixture when mixed according to ASTM C94 conditions, is very high. The occurrence of more of two individual fibrous units 10 still held together after such mixing is generally rare. As referenced to the number of original rib members 2 in its fibrous source material or element 1, at least 80%, particularly at least 90%, more particularly at least about 95%, and even more particularly at least about 98%, of the individual fibrous units are released from the fibrous material 1. For example, for a 90% release of individual fibrous units 1 for a discrete length of fibrous ribbon material 1 having 20 ribs (2) spaced apart across its width, then an average of 18 individual fibrous units per each fibrous material element 1 are released (i.e., 18/20) for the a given amount of the fibrous material 1. Also, the subunits remain durably attached to the main element during wet concrete mixing and curing. In one embodiment, greater than about 90%, particularly greater than about 95%, and more particularly greater than about 98% of the total subunits of the fibers stay attached to the main filament elements through wet mixing and curing of concrete reinforced by them. Also, the combination of subunits having fine hair like structures as well as short stubby or barbed structures enhances anchoring capabilities of the fibrous unit and helps increase surface energy differences between different fibrous units to improve the three-dimensional dispersability of the fibrous units within concrete and reduce nesting and unwanted alignment problems.

The synthetic reinforcement fibrous material construction exhibits a modulus at 30% elongation 3.0 and 9.5 Gpa, and preferably in the range of between 3.0 and 8.5 Gpa, and most preferably between 3.0 and 5.0 Gpa. In particular embodiments, the synthetic reinforcement fibrous material disperses fibrous units within cementitious material effective to improve procure and post cure properties of cementitious products. For example, an average residual strength per ASTM C1399 can be provided in such concrete products of at least 190 psi at 5 lb per cubic yard loading at 8 days cure, a residual strength per ASTM C1399 of at least 140 psi at 4 lb per cubic yard loading at 8 days cure, and a residual strength per ASTM C1399 of at least 80 psi, particularly at least 110 psi, at 3 lb per cubic yard loading at 8 days cure. Fiber reinforced concrete building products according to this invention exhibit a 20% increase over a control to initiate crack per ASTM C1609. For this discussion, the “control” refers to the otherwise same concrete product except it lacks the reinforcement fibrous material. The fiber reinforced concrete building products also exhibit a crack reduction per ASTM C1579 of at least 50% of control.

As indicated, improved hydratable cementitious compositions and fiber-reinforced concrete building products incorporating the synthetic reinforcement fibrous materials are also provided within additional embodiments of the invention. The synthetic reinforcement fibrous material may be used in preparing a concrete mix that is formed and cured to provide an improved fiber-reinforced concrete building product. The cement mix can include Portland cement and/or other hydratable cementitious material. It may be in dry or wet forms. The synthetic reinforcement fibrous material of embodiments of the present invention can be separately packaged, such as in water dispersible bags, for introduction into a concrete mix at any time before, during or after concrete mixing. The synthetic reinforcement fibrous material can be introduced into and dispersed with ready mixed concrete, such as by using conventional concrete mix agitating or stirring means and methods before the mix sets and hardens. Alternatively, the synthetic fibrous material can be pre-packaged as a mixture with one or more other concrete mix components, such as Portland cement and the like and/or other concrete ingredients, such as, e.g., supplementary cementitious materials (e.g., fly ash, slag, etc.), aggregates (e.g., sand, gravel, crushed stone, etc.), and/or conventional chemical admixtures used for concrete (e.g., air-entraining admixtures, accelerating admixtures, corrosion inhibitors, etc.). Concrete products of embodiments of the present invention generally may be a mixture of aggregates, paste and the synthetic fiber material. The paste, typically comprised of cement and water, binds the aggregates (usually sand and gravel or crushed stone) into a rocklike mass as the paste hardens because of the chemical reaction of the cement and water. Supplementary cementitious materials and chemical admixtures may also be included in the paste; with particular note made to the fact that the separable fibrous units of the instant invention is essentially non-reactive to such conventional supplementary materials. The synthetic reinforcement fibrous material of the present invention can be dosed in concrete at rates of at least about 1.5 pound per cubic yard, and may range between about 1.5 to about 7.5 pounds per cubic yard, although the preferred amount may vary depending on the particular application. The synthetic fibrous materials particularly may be used in precast and slab on ground. Among other improvements, the concrete building product has improved micro-crack control (against propagation) while maintaining good conformability and strength contribution from the synthetic fibrous material of embodiments herein. Unlike conventional rigid reinforcing fibers, such as steel fibers or the like, the inventive separable fibers do not tend to displace aggregate within the cementitious mix, which helps to ensure a uniform concrete construct or matrix is obtained. The concrete form also has good finishability as the synthetic fiber material is conducive to finishing operations.

The reinforcing fibrous material and releasable fibrous units of the present invention are particularly useful in precast concrete as a secondary reinforcement, and for the purpose of controlling plastic shrinkage and settlement cracking. It should be noted that application of a continuous filament having a fibrous construction in accordance with teachings herein may also be applied to soil stabilization uses.

As other advantages and benefits of the present invention, the inventive reinforcing fibrous material and releasable individual fibrous units thereof are non-abrasive, alkali-resistant, non-ferrous/non-corrosive, and do not promote mold growth. They help control flow of bleed water to minimize “layered” loss of strength (i.e., highest to lowest based on direction of water bleed). The fibrous subunits bridge through plastic micro-cracks caused by low humidity, high winds, and high air temperatures. Thus, effective shrinkage and settlement control can be provided using the inventive reinforcement fibrous systems. The fiber system of the present invention becomes rooted in cured concrete to increase crack resistance to cracking by increasing force necessary to cause a break and then redistributes force so a crack is resistant to spreading well before any primary steel reinforcement needs to come into play. The inventive reinforcement system is a suitable replacement for welded wire fabric, conventional light gauge steel reinforcement (e.g., #3/#4 rebar), and steel fiber, and is highly compatible with all tied steel applications as a tertiary reinforcement. They also reduce handling and transportation stresses. Concrete reinforced with the inventive reinforcing fibrous material has a uniform porosity on exposed faces; lower permeability, higher resistance to moisture transfer in subterranean applications; reduced sealer consumption; and higher abrasion resistance. Three-dimensional “corner to corner” reinforcement is provided with the inventive fibers as micro fibers, with enhanced finishability and conformability. The reduction of micro-cracks obtained by using the inventive fibrous material in concrete reduces the ability of water to intrude into concrete and improves freeze/thaw induced large cracks. The combined non-corrosive, high conformability/dispersability, non-occlusive, and micro-crack reduction features, and so forth, of the inventive reinforcement material and fibrous units released therefrom allow for its use in more extreme concrete environments, such as pervious concrete. An enhanced uniformity of aggregate placement is attained as the reinforcement fibrous units complexes maintain aggregate in suspension during plastic phase of concrete. Fibers exposed on the concrete surface are non-functional and may be easily finished, such as via burning them off or, if left alone, exposed fiber ends thereof will solar degrade over a relatively short period of time (e.g., several months). Improved and high early green strengths (e.g., in less than 12 hours) obtained in cementitious mixtures reinforced with the inventive fibrous material allows for earlier stripping of forms (e.g., mold strips) while holding closer tolerances to precast forms and thus less rejection, reduction in green strength specific reinforcement steel, enhanced edge and surface integrity, reductions in rework, resistance to impact spalling, and thus providing reduced production time and overall material costs. The low mass of the inventive fibrous units also significantly reduces issues of secondary projectiles under impact.

The examples that follow are intended to further illustrate, and not limit, embodiments in accordance with the invention. All percentages, ratios, parts, and amounts used and described herein are by weight unless indicated otherwise.

Mix Design. For purposes of this application, the following concrete mixing and testing protocols are used to assess performance of fibrous reinforcing materials in mixed concrete, unless indicated otherwise.

TABLE I

| Concrete Mix Design Ingredients | lbs./yd³ |
|---|---|
| Portland Cement (Type I) | 905.9 |
| Fine Aggregate (natural sand) | 1358.8 |
| Course Aggregate (small river rock - pea | 1358.8 |
| gravel) | |
| Water | 362.3 |
| W/C ratio | 0.40 |

TABLE II
Testing Conditions: Environmental Chamber Test Requirements

| | |
|---|---|
| Temperature, ° F. | 36° C. +/− 3 |
| Relative Humidity, % | 30 +/− 10% |
| Air Velocity, m/sec. | 4.7 m/s minimum |
| Moisture Loss, lbs./ft²/hr. | 0.20 lbs. minimum |

TABLE III

Testing Protocols
Test Units: A test unit is at least six test specimens.
Three are control specimens without fibers. The other
specimens are identical except they contain specified
amounts and types of fiber. Control concrete specimens
may be compared to more than one series of fiber-
reinforced concrete specimens.
Test Apparatus
Molds: A mold with a depth of 4 inches (102 mm), a
minimum surface area of 1.75 square feet (0.16 m2),
and rectangular dimensions of 14 inches by 22 inches
(356 mm by 559 mm), with internal restraint and stress
risers. The mold shall be fabricated from metal,
plastic or plyform. Fabricate the plastic or plyform.
Fabricate the internal restraints and stress riser for a
separate sheet metal piece. This sheet metal piece shall
seat snugly at the bottom of the mold.
Restraint: Two 1.25-inch (31.7 mm) risers, placed 4
inches (102 mm) inward from each end of the mold, provide
restraint to the concrete. The center 2.5-inch (63.5 mm)
stress riser serves as an inhibition point for plastic
shrinkage cracking
The cracking values of each panel shall be computed by
multiplying crack lengths by their associated average
widths and accumulating these products to determine the
specimen's total cracking value (mm²).
Cracking value (FRC)/Cracking value (control) × 100%
Test Results
The results shall be evaluated on the basis of averaging
the test results. Any peculiar individual test results
shall be noted.
The minimum accepted for the final results shall be that
synthetic fibers decrease the plastic shrinkage cracking
of concrete by 40 percent.

### EXAMPLES

### Example 1

Two samples of fibrous synthetic fibrous materials were manufactured representing embodiments of the present invention. The synthetic fibrous materials for these two production lots of reinforcing fiber product were designated Samples “1” and “2” for purposes of this example. The fibrous materials were prepared with a composition containing: 77.5% 5.0 Melt polypropylene homopolymer, 2.5% black color concentrate (comprised of a 0.285% carbon black, 5.415% LDPE, and 94.3% LLDPE), and 20% reprocessed component comprised of a 4:1 refractional melt polypropylene to LLDPE blend. The polypropylene homopolymer, refractional melt polypropylene, and linear polyethylene components can have properties such as described hereinabove.

To prepare the synthetic fibrous materials 1 and 2, compositions as described hereinabove were processed on an apparatus generally represented by and described above with reference to FIG. 4 and using an extrusion die described above with reference to FIG. 5. A striated ribbon sheet was extruded using a serrated extrusion die in the form of striated ribbon comprising longitudinally extending alternating ribs and webs. The striated ribbon 21 was incrementally drawn (stretched) using Godet rolls at following draw conditions: draw ration 9:1, oven temperature 300° F. The drawn striated ribbon was transversely cut into discrete lengths of about 3.0-50 mm.

The following properties, and applied test methods, were measured for a plurality of reinforcement fibrous elements containing individual fibrous units from each production lot and averaged, with the results indicated in Tables 1 and 2: linear density (ASTM D1577-Standard Test Methods for Linear Density of Textile Fibers), elongation as % peak strain (ASTM D3822-Standard Test Method for Tensile Properties of Single Textile Fibers), Young's Modulus at 30% elongation (ASTM D3822), and tenacity (ASTM D3822).

As a comparative reinforcing material, a synthetic fiber netting material (designated “1C” for purposes of this example) was prepared using a slitting process to “fibrillate” a tape into a net configuration, and a plurality of the comparative products were measured for similar properties and averaged, with the results indicated in Table 3.

To prepare the comparison synthetic fiber material “1C”, a polypropylene/polyethylene resin blend was film extruded, uniaxially oriented, fibrillated, and cut to discrete length. The fibrillation process included use of mechanical fibrillation means having the general layout of the above-mentioned U.S. patents pertaining to mechanical fibrillation systems, with the adaptation/modification including the use of a pin spacing of ≧10 pins/cm, a pin density of ≧5.5 pins per square cm, and a pin rate of ≧40 percent, providing fibrous lace-like product having at least 5% fibrillation per square inch. The reinforcing material was cut into about 38 mm lengths.

TABLE 1
Sample 1

| Linear Density | Tensile | Elongation | Young's | |
|---|---|---|---|---|
| (lbs./ | Peak Load | (% Peak | Modulus | Tenacity |
| 10,000 ft.) | (lbs.) | Strain) | (Gpa) | (lbs./ld) |
| 1.866 | 33.320 | 17.958 | 4.484 | 17.856 |
| 1.866 | 28.890 | 20.870 | 3.840 | 15.482 |
| 1.866 | 28.320 | 14.770 | 4.525 | 15.177 |
| 1.866 | 29.070 | 13.200 | 4.568 | 15.579 |
| 1.866 | 29.340 | 15.558 | 3.654 | 15.723 |
| 1.860 | 31.190 | 18.448 | 3.814 | 16.769 |
| 1.860 | 30.740 | 24.556 | 3.428 | 16.527 |
| 1.860 | 30.950 | 19.395 | 4.526 | 16.640 |
| 1.860 | 32.830 | 16.786 | 4.809 | 17.651 |
| 1.860 | 27.790 | 17.026 | 3.559 | 14.941 |
| 1.890 | 32.130 | 13.825 | 4.525 | 17.000 |
| 1.890 | 30.440 | 16.301 | 4.193 | 16.106 |
| 1.890 | 32.510 | 21.626 | 3.882 | 17.201 |
| 1.890 | 30.250 | 18.828 | 3.998 | 16.005 |
| 1.890 | 31.060 | 19.225 | 3.321 | 16.434 |
| 1.890 | 28.910 | 19.049 | 4.027 | 15.296 |
| Avg. = | Avg. = | Avg. = | Avg. = | Avg. = |
| 1.865 | 30.484 | 17.964 | 4.072 | 16.274 |

TABLE 2
Sample 2

| Linear Density | Tensile | Elongation | Young's | |
|---|---|---|---|---|
| (lbs./ | Peak Load | (% Peak | Modulus | Tenacity |
| 10,000 ft.) | (lbs.) | Strain) | (Gpa) | (lbs./ld) |
| 2.114 | 37.930 | 14.839 | 5.937 | 17.942 |
| 2.114 | 33.990 | 14.272 | 4.579 | 16.079 |
| 2.114 | 38.550 | 16.295 | 5.107 | 18.236 |
| 2.114 | 35.520 | 16.478 | 5.148 | 16.802 |
| 2.114 | 31.250 | 16.497 | 4.568 | 14.782 |
| 2.176 | 36.940 | 17.694 | 5.565 | 16.976 |
| 2.176 | 32.590 | 16.553 | 4.859 | 14.977 |
| 2.176 | 36.130 | 15.961 | 5.938 | 16.604 |
| 2.176 | 36.940 | 15.463 | 5.813 | 16.976 |
| 2.176 | 36.590 | 14.909 | 5.453 | 16.815 |
| Avg. = | Avg. = | Avg. = | Avg. = | Avg. = |
| 2.124 | 35.643 | 15.896 | 5.297 | 16.802 |

TABLE 3
Comparison Fiber 1C

| Linear Density | Tensile | Elongation | Young's | |
|---|---|---|---|---|
| (lbs./ | Peak Load | (% Peak | Modulus | Tenacity |
| 10,000 ft.) | (lbs.) | Strain) | (Gpa) | (lbs./ld) |
| 2.020 | 26.360 | 8.660 | 6.050 | 13.060 |
| 2.050 | 25.120 | 8.160 | 6.100 | 12.260 |
| 2.040 | 25.460 | 7.880 | 6.330 | 12.500 |
| 2.040 | 27.180 | 8.320 | 6.010 | 13.320 |
| 2.050 | 25.900 | 7.960 | 6.570 | 12.660 |
| 2.040 | 25.520 | 9.740 | 5.600 | 12.530 |
| 2.050 | 25.440 | 8.760 | 5.540 | 12.410 |
| 2.070 | 25.080 | 8.180 | 5.940 | 12.140 |
| 2.090 | 26.760 | 9.320 | 5.670 | 12.780 |
| 2.060 | 25.840 | 9.120 | 5.180 | 12.560 |
| 2.030 | 24.720 | 8.480 | 6.230 | 12.210 |
| 2.080 | 21.300 | 9.360 | 4.320 | 10.240 |
| 2.030 | 25.720 | 9.980 | 5.370 | 12.700 |
| 2.000 | 24.620 | 9.040 | 5.540 | 12.280 |
| 2.010 | 25.660 | 8.520 | 6.140 | 12.760 |
| 2.020 | 25.980 | 9.200 | 5.760 | 12.830 |
| 2.020 | 24.820 | 8.840 | 5.790 | 12.290 |
| 2.050 | 26.320 | 9.680 | 5.830 | 12.850 |
| 2.050 | 25.720 | 7.940 | 6.430 | 12.570 |
| 2.090 | 25.000 | 9.000 | 5.760 | 11.990 |
| 2.090 | 26.100 | 8.560 | 6.040 | 12.460 |
| 2.070 | 26.560 | 9.300 | 5.950 | 12.870 |
| 2.120 | 26.020 | 9.460 | 5.400 | 12.300 |
| Avg. = | Avg. = | Avg. = | Avg. = | Avg. = |
| 2.051 | 25.53 | 8.846 | 5.807 | 12.460 |

As seen in these results, the inventive fiber materials exhibit improved superior tensile strength, elongation, Young's Modulus and tenacity properties at a comparable linear density value for the compared fibrous reinforcing materials.

From the foregoing, it will be observed that numerous modifications and variations can be affected without departing from the true spirit and scope of the novel concept of the present invention. It is to be understood that no limitation with respect to the specific embodiments illustrated herein is intended or should be inferred. The disclosure is intended to cover, by the appended claims, all such modifications as fall within the scope of the claims.

What is claimed is:

1. A synthetic reinforcement fibrous material comprising a plurality of parallel-extending spaced-apart main filament filaments interconnected by intervening integral webbing material, wherein individual fibrous units are separable from said reinforcement fibrous material during mixing of the fibrous material and a curable cementitious material, wherein, upon separation, said individual fibrous units each comprise a main filament element having opposite sides and a plurality of integral fibrous subunits each laterally extending from both main filament element sides at a random frequency along said opposite sides and having random respective lengths.

2. The synthetic reinforcement fibrous material of claim 1, wherein said synthetic reinforcement material is formed from a polymer composition comprising about 0.05% to about 40% by weight of a refractional melt polypropylene polymer, about 50% to about 98% by weight polypropylene homopolymer having a lower melt flow rate than the refractional melt polypropylene polymer, and about 1% to about 10% by weight of linear polyethylene.

3. The synthetic reinforcement fibrous material of claim 1, wherein said synthetic reinforcement fibrous material is formed from a polymer composition comprising about 50% to about 98% by weight polypropylene homopolymer, about 1% to about 10% by weight of linear polyethylene, and less than about 0.05% by weight of refractional melt polypropylene polymer.

4. The synthetic reinforcement fibrous material of claim 1, wherein said main filament element has a staple fiber length of about 6 mm to about 80 mm, and said subunits have a length averaging about 10 microns to about 80 mm.

5. The synthetic reinforcement fibrous material of claim 1, wherein said subunits have a diameter that is up to about 20% of the diameter of the main filament element.

6. The synthetic reinforcement fibrous material of claim 1, wherein said fibrous units have an overall cross sectional area and a cross sectional geometry inclusive of the main filament element and subunits at a location along a length of the main filament element, at which at least one subunit has a proximal end and each of said main filament element and at least one subunit have a respective cross sectional area and a cross sectional geometry, and said main element cross sectional area is between 75 and 99.9% of the overall fibrous unit cross sectional geometry and said at least one subunit, having a cross sectional area that is between 0.1 to 25% of the overall fibrous unit cross sectional geometry.

7. The synthetic reinforcement fibrous material of claim 1, wherein said fibrous units have a main filament element having a cross sectional dimension ratio defined by intersecting perpendicular lines that transect a central point of the main filament element cross-section of between 1 and 3.

8. The synthetic reinforcement fibrous material of claim 1, said fibrous material exhibits a Young's modulus at 30% elongation of between 3.0 and 9.5 Gpa.

9. Individual fibrous units comprising a main filament element having opposite sides and a plurality of integral fibrous subunits laterally extending from both main filament element sides at a random frequency along said opposite sides and having random respective lengths.

10. The fibrous units of claim 9, wherein said fibrous units are formed with a polymer composition comprising about 0.05% to about 40% by weight of a refractional melt polypropylene polymer, about 50% to about 98% by weight polypropylene homopolymer having a lower melt flow rate than the refractional melt polypropylene polymer, and about 1% to about 10% by weight of a linear polyethylene.

11. A cementitious composition containing a hydratable cementitious material and a synthetic reinforcement fibrous material according to claim 1.

12. A fiber reinforced concrete building product containing a matrix comprising the cured product of a mixture including hydratable cementitious material and moisture, and a plurality of synthetic reinforcement fibrous units substantially uniformly dispersed throughout the matrix, wherein said synthetic reinforcement fibrous units each comprise a main filament element having opposite sides and a plurality of integral fibrous subunits each laterally extending from both main element sides at a random frequency along said opposite sides and having random respective lengths.

13. The fiber reinforced concrete building product of claim 12, wherein said fibrous units are dosed in a concrete matrix at a rate of between about 1.5 to about 7.5 pounds of fibrous units per cubic yard of concrete mix.

14. The fiber reinforced concrete building product of claim 12, wherein said synthetic reinforcement fibrous units are formed from a polymer composition comprising about 0.05% to about 40% by weight of a refractional melt polypropylene polymer, about 50% to about 98% by weight polypropylene homopolymer having a lower melt flow rate than the refractional melt polypropylene polymer, and about 1 to about 10% by weight of linear polyethylene.

15. The fiber reinforced concrete building product of claim 12, wherein said cementitious material is selected from the group consisting of stucco, mortar, grout, and concrete.

16. The fiber reinforced concrete building product of claim 12, wherein said cementitious material is concrete.

17. The fiber reinforced concrete building product of claim 12, wherein said product exhibits a residual strength per ASTM C1399 of at least 80 psi at 3 lbs. per cubic yard loading at 8 days cure.

18. The fiber reinforced concrete building product of claim 12, wherein said product exhibits a residual strength per ASTM C1399 of at least 140 psi at 4 lbs. per cubic yard loading at 8 days cure.

19. The fiber reinforced concrete building product of claim 12, wherein said product exhibits an amount of force to initiate crack per ASTM C1609 of at least 20% greater than the otherwise same product except lacking the reinforcement fibrous material.

20. The fiber reinforced concrete building product of claim 12, wherein said product exhibits a crack reduction per ASTM C1579 of at least 50% of the otherwise same product except lacking the reinforcement fibrous material.

21. A method of making synthetic reinforcement fibrous material, comprising:
extruding a striated ribbon from a thermoplastic material, wherein said extruded striated ribbon comprises a plurality of substantially uniformly, laterally spaced parallel ribs extending continuously and longitudinally of the ribbon, and adjacent pairs of the ribs are interconnected by integral thermoplastic webs of reduced thickness as compared to the ribs;
longitudinally slitting the extruded striated ribbon to provide a plurality of continuous striated ribbons of smaller width than the extruded striated ribbon;
drawing the slit striated ribbons at a draw ratio between 8:1 and 10:1 under heated conditions effective to orient the ribbons;
intermittently transversely cutting the ribbons to provide a plurality of discrete length reinforcement fibrous materials each comprising a plurality of individual fibrous units that are separable from said reinforcement fibrous material.

22. The method of claim 21, further comprising selecting, as the thermoplastic material, a polymer composition comprising about 0.05% to about 40% by weight of a refractional melt polypropylene polymer, and about 50% to about 98% by weight polypropylene homopolymer having a lower melt flow rate than the refractional melt polypropylene polymer, and about 1% to about 10% by weight of linear polyethylene, for processing by said extruding step.

23. The method of claim 21, further comprising the step of packaging the discrete length reinforcement fibrous materials in a water-dispersible package.

24. The method of claim 21, further comprising mixing said fibrous material and a curable cementitious material effective to release said individual fibrous units from the fibrous material for admixture with and dispersion in the cementitious material, said fibrous units comprising a main filament element having opposite sides and a plurality of integral fibrous subunits each laterally extending from both main filament element sides at a random frequency along said opposite sides and having random respective lengths effective to substantially uniformly disperse in, conform to, and increase anchoring within the cementitious material.
